(19) United States
(12) Patent Application Publication
(10) Pub. No.: US 2007/0270189 A1
(43) Pub. Date: Nov. 22, 2007

(54) Embedded mobile phone handfree system for an automobile

(75) Inventor: Teh-Yi Chuang, Hsichih City (TW)

Correspondence Address: POSZ LAW GROUP, PLC, 12040 SOUTH LAKES DRIVE, SUITE 101, RESTON, VA, 20191, US

(73) Assignee: TAIGAS INC., Taipei Hsien (TW)

(21) Appl. No.: 11/434,076

(22) Filed: May 16, 2006

(51) Int. Cl. H04M 1/00

(52) U.S. Cl. 455/569.2

(57) ABSTRACT

An embedded mobile phone handfree system is mounted in an audio/video telematics slot of an automobile and has an embedded handfree device and a mobile phone. The embedded handfree device has a casing, a mobile phone connecting interface and an automobile connecting interface. The casing has a phone slot defined in the casing. The mobile phone is mounted detachably in the phone slot in the casing and has an embedded handfree device connecting interface detachably engaging with the mobile phone connecting interface. The embedded handfree device in the audio/video telematics slot does not occupy any parts of the internal space of the automobile so the user may fully use the internal space in the automobile.

### BACKGROUND OF THE INVENTION

1. Field of the Invention

The present invention relates to a phone system, and more particularly to an embedded mobile phone handfree system for an automobile that is embedded compactly in an audio/video telematics slot in an automobile and does not occupy any parts of the internal space of the automobile.

2. Description of Related Art

Mobile phones are common communication apparatuses and are used widely nowadays. However, a driver hardly uses the mobile phone while driving because the driver always needs to hold the steering wheel with hands. Furthermore, drivers are not allowed to using mobile phones according to the traffic law in several countries in order to avoid traffic accidents.

A conventional mobile phone handfree device for an automobile has been developed to allow drivers to use a mobile phone without hands when driving and has a speaker, a mike, a phone slot and a power cord with a plug. The mobile phone handfree device is put above a dashboard of the automobile and the plug of the power cable is plugged to a cigar-lighter slot in the dashboard to charge. Drivers may put a mobile phone in the phone slot and communicate with other person through the mobile phone handfree device without holding the mobile phone. Their voice may transmit through the mike and a person's voice on the opposite side may broadcast through the speaker. However, the mobile phone handfree device above the dashboard occupies a part of the limited internal space in the automobile and the exposed power cord disadvantages the driver's operation to buttons or keys on the dashboard.

Another conventional mobile phone handfree device is integrated into the automobile and has a phone securely connecting to the automobile. However, the phone cannot be detached from the automobile, has no portability and cannot be used as a mobile phone.

To overcome the shortcomings, the present invention provides for an automobile to mitigate or obviate the aforementioned problems.

### SUMMARY OF THE INVENTION

The main objective of the invention is to provide an embedded mobile phone handfree system that is embedded compactly in an audio/video telematics slot in an automobile and does not occupy any parts of the internal space of the automobile.

An embedded mobile phone handfree system in accordance with the present invention is mounted in an audio/video telematics slot of an automobile and comprises an embedded handfree device and a mobile phone.

The embedded handfree device has a casing, a mobile phone connecting interface and an automobile connecting interface. The casing has a phone slot defined in the casing.

The mobile phone is mounted detachably in the phone slot in the casing and has an embedded handfree device connecting interface detachably engaging with the mobile phone connecting interface.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of an embedded mobile phone handfree system in accordance with the present invention with embedded handfree device having a one din casing;

FIG. 2 is an exploded perspective view of the embedded mobile phone handfree system with embedded handfree device having a two din casing;

FIG. 3 is a perspective view of a second embodiment of an embedded mobile phone handfree system in accordance with the present invention;

FIG. 4 is an operational top view of the embedded mobile phone handfree system in FIG. 3 with the tray pivoting out of the phone slot;

FIG. 5 is a side view of a third embodiment of an embedded mobile phone handfree system in accordance with the present invention;

FIG. 6 is a side view of a fourth embodiment of an embedded mobile phone handfree system in accordance with the present invention;

FIG. 7 is a perspective view of a fifth embodiment of an embedded mobile phone handfree system in accordance with the present invention; and

FIG. 8 is a side view of the embedded mobile phone handfree system in FIG. 7.

### DETAILED DESCRIPTION OF THE PREFERRED EMBODIMENT

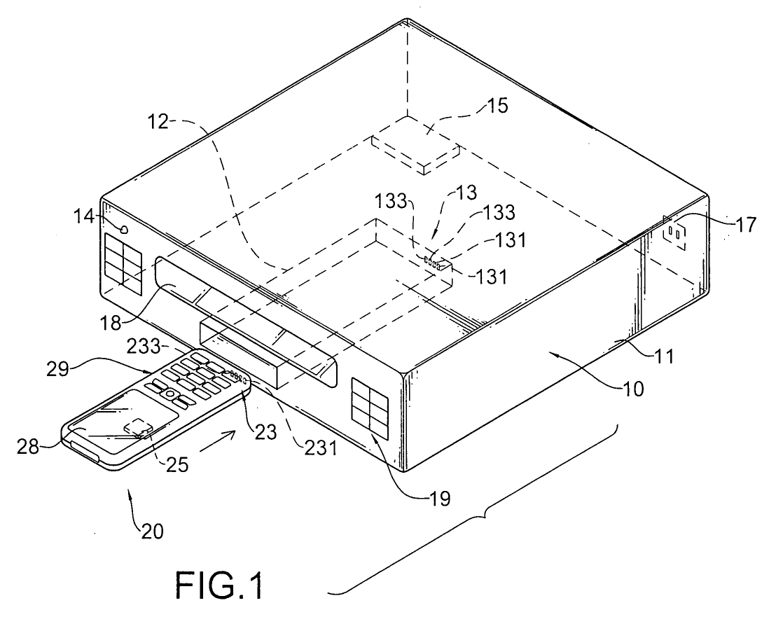

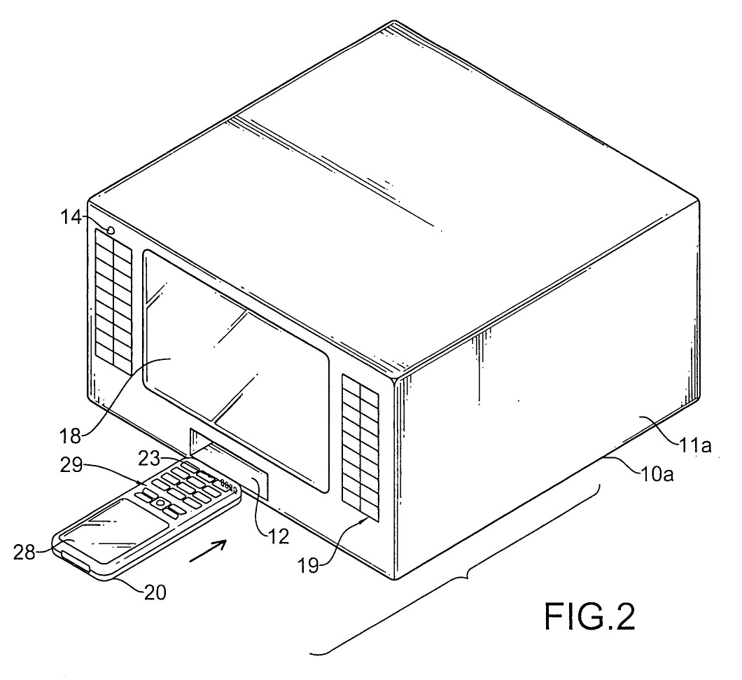

With reference to FIGS. 1 and 2, a first embodiment of an embedded mobile phone handfree system in accordance with the present invention is embedded compactly in an automobile. The automobile has a dashboard, an audio/video telematics slot and a speaker. The audio/video telematics slot may be a one din audio/video telematics slot with a width of 178 millimeters (mm), a height of 50 mm and a depth of 180 mm, may be a two din audio/video telematics slot with a width of 178 mm, a height of 100 mm and a depth of 180 mm or may be a customized audio/video telematics slot.

The embedded mobile phone handfree system comprises an embedded handfree device (10) and a mobile phone (20).

The embedded handfree device (10) has a casing (11), a phone slot (12), a mike (14), a display (18), an operating interface (19), a control circuit (15), a mobile phone connecting interface (13) and an automobile connecting interface (17).

The casing (11) is mounted and embedded in the audio/video telematics slot in the automobile, may be a one din casing with a width of 178 millimeters (mm), a height of 50 mm and a depth of 180 mm, may be a two din casing with a width of 178 mm, a height of 100 mm and a depth of 180 mm or may be a customized casing. The casing (11) has a front and a rear.

The phone slot (12) is defined in the front of the casing (11).

The mike (14) and the display (18) are mounted on front of the casing (11).

The operating interface (19) is mounted on the front of the casing (11) and may comprise buttons, knobs and keys.

The control circuit (15) is mounted in the casing (11) and connects to the mike (14), display (18) and operating interface (19).

The mobile phone connecting interface (13) is mounted in the phone slot (12), connects to the control circuit (15) and has multiple signal receiving contacts (131) and multiple signal transmitting contacts (133).

The automobile connecting interfacing (17) is mounted on the rear of the casing (11), connects to the control circuit (15) and the automobile so a user can operate the speaker of the automobile through the embedded handfree device (10).

The mobile phone (20) is mounted detachably in the phone slot (12) in the casing (11) and has a front, a rear, a bottom, a display (28), an operating interface (29), a control circuit (25) and an embedded handfree device connecting interface (23).

The display (28) is mounted on front of the mobile phone (20).

The operating interface (29) is mounted on the front of the mobile phone (20) and may comprise buttons, knobs and keys.

The control circuit (25) is mounted in the mobile phone (20) and connects to the display (28) and operating interface (29).

The embedded handfree device connecting interface (23) is mounted on the bottom of the mobile phone (20), connects to the control circuit (25) in the mobile phone (20), detachably engages with the mobile phone connecting interface (13) and has multiple signal transmitting contacts (233) corresponding to the signal receiving contacts (131) of the mobile phone connecting interface (13) and signal receiving contacts (231) corresponding to the signal transmitting contacts (133) of the mobile phone connecting interface (13). The connection of the embedded handfree device connecting interface (23) and mobile phone connecting interface allows the mobile phone (20) to sound through the speaker of the automobile and to receive a user's sound through the mike (14) on the embedded handfree device (10) so the user can communicate with other person without his hand holding the mobile phone (20). Furthermore, the user may immediately obtain the information by watching the display (18) on the embedded handfree device (10) and may control the mobile phone (20) by operating the operating interface (19) of the embedded handfree device (10).

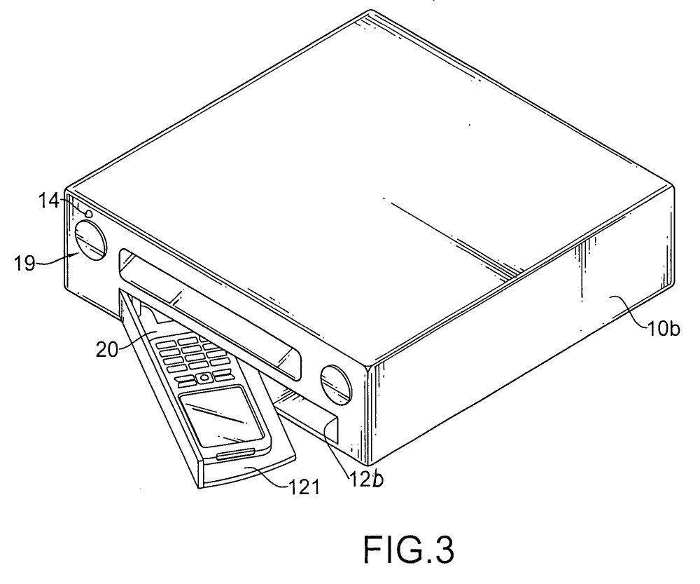

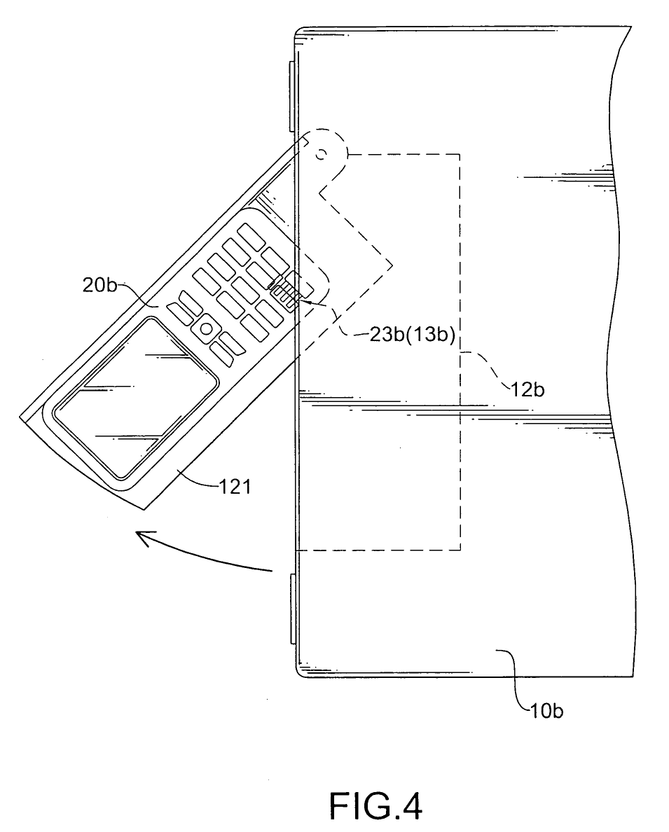

With reference to FIGS. 3 and 4, a second embodiment of the embedded mobile phone handfree system is similar to the first embodiment and has the phone slot (12b) of the embedded handfree device (10b) further having a tray (121). The tray (121) is mounted pivotally in the phone slot (12b), has a top and holds the mobile phone (20) on the top. The mobile phone connecting interface (13b) is mounted on the top of the tray (121) and the embedded handfree device connecting interface (23b) is mounted on the rear of the mobile phone (20b).

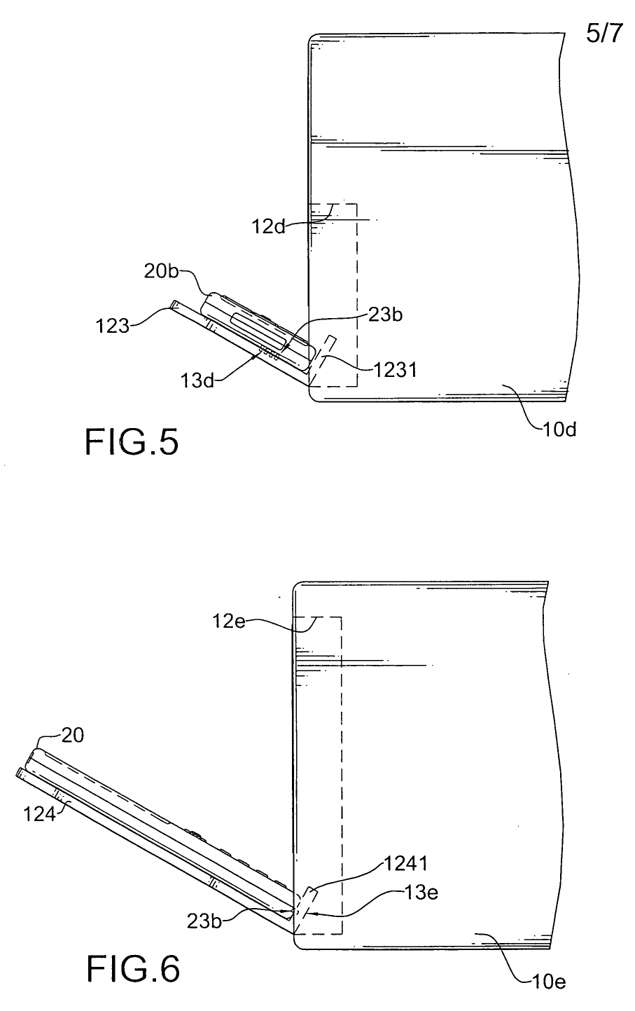

With reference to FIG. 5, a third embodiment of the embedded mobile phone handfree system is similar to the second embodiment and has the phone slot (12d) of the embedded handfree device (10d) further having a cover (123). The cover (123) is mounted pivotally in and covers the phone slot (12d) and has an inside surface and a seat (1231). The seat (1231) extends out from the inside surface and holds the mobile phone (20b). The mobile phone connecting interface (13d) is mounted on the inside surface.

With reference to FIG. 6, a fourth embodiment of the embedded mobile phone handfree system is similar. The mobile phone connecting interface (13e) is mounted on the seat (1241) of the cover (124) on the embedded handfree device (10e) and the embedded handfree device connecting interface (23b) is mounted on the bottom of the mobile phone (20).

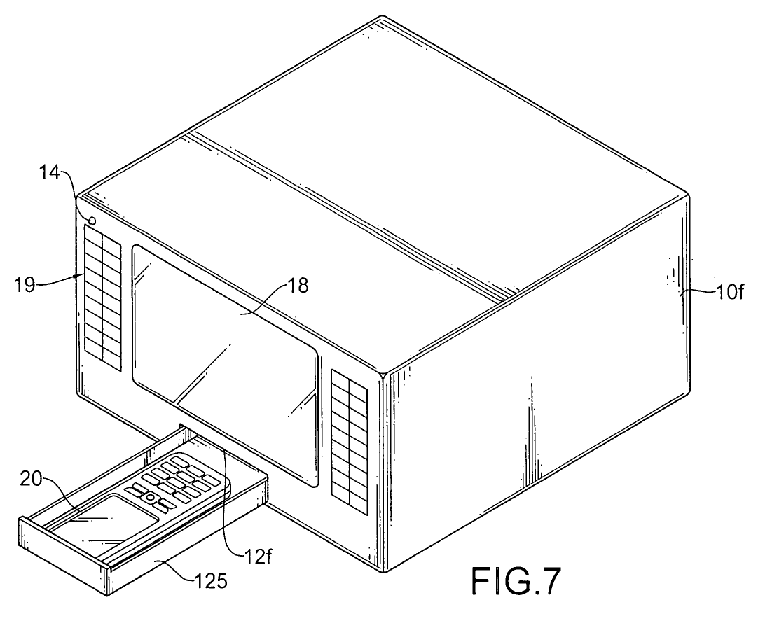

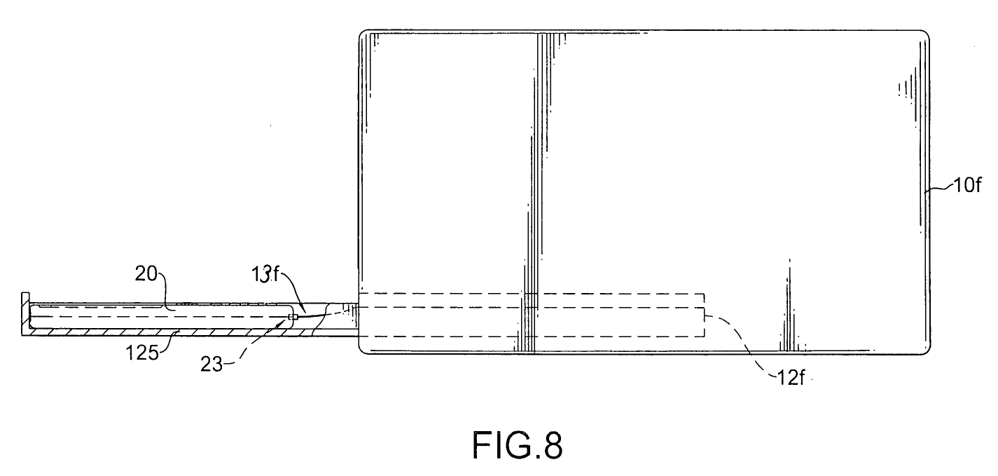

With reference to FIGS. 7 and 8, a fifth embodiment of the embedded mobile phone handfree system is similar to the first embodiment and has the phone slot (12f) of the embedded handfree device (10f) further having a tray (125). The tray (125) is mounted slidably in the phone slot (12f), has a top and holds the mobile phone (20) on the top. The mobile phone connecting interface (12f) has a connecting cable having two ends. One end is mounted securely in the phone slot (12f) and the other end is a free end and is mounted to the signal transmitting and receiving contacts (131, 133) of the mobile phone connecting interface (13).

The embedded mobile phone handfree system allows a user in the automobile to use the mobile phone without holding the mobile phone with hands. When leaving the automobile, the user may carry and use the mobile phone independently. Furthermore, the embedded handfree device (10) in the audio/video telematics slot does not occupy any parts of the internal space of the automobile so the user may fully use the internal space in the automobile.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An embedded mobile phone handfree system adapted for being embedded in an audio/video telematics slot of an automobile and comprising:
an embedded handfree device having
a casing adapted for being mounted and embedded in the audio/video telematics slot and having a front;
a phone slot defined in the front of the casing;
a mike mounted on the casing;
a display mounted on the front of the casing;
an operating interface mounted font of the casing;
a control circuit mounted in the casing and connecting to the mike, display and operating interface;
a mobile phone connecting interface mounted in the phone slot and connecting to the control circuit; and
an automobile connecting interface mounted on the casing, connecting to the control circuit and adapted for connecting to the automobile; and
a mobile phone mounted detachably in the phone slot in the casing and having
a front;
a rear;
a bottom;
a control circuit mounted in the mobile phone; and
an embedded handfree device connecting interface mounted on the mobile phone, connecting to the control circuit in the mobile phone and detachably engaging with the mobile phone connecting interface.

2. The embedded mobile phone handfree system as claimed in claim 1, wherein the casing is a one din casing with a width of 178 mm, a height of 50 mm and a depth of 180 mm.

3. The embedded mobile phone handfree system as claimed in claim 1, wherein the casing is a two din casing with a width of 178 mm, a height of 100 mm and a depth of 180 mm.

4. The embedded mobile phone handfree system as claimed in claim 1, wherein:
the phone slot in the casing of the embedded handfree device further has a tray mounted pivotally in the phone slot, having a top and holding the mobile phone on the top;
the mobile phone connecting interface is mounted on the top of the tray; and
the embedded handfree device connecting interface is mounted on the rear of the mobile phone.

5. The embedded mobile phone handfree system as claimed in claim 1, wherein the phone slot in the casing of the embedded handfree device further has a cover mounted pivotally in and covering the phone slot and having an inside surface and a seat extending out from the inside surface and holding the mobile phone.

6. The embedded mobile phone handfree system as claimed in claim 5, wherein the mobile phone connecting interface is mounted on the inside surface and the embedded handfree device connecting interface is mounted on the rear of the mobile phone.

7. The embedded mobile phone handfree system as claimed in claim 5, wherein the mobile phone connecting interface is mounted on the seat and the embedded handfree device connecting interface is mounted on the bottom of the mobile phone.

8. The embedded mobile phone handfree system as claimed in claim 1, wherein:
the phone slot further has a tray mounted slidably in the phone slot and having and holding the mobile phone on the top; and
the mobile phone connecting interface has a connecting cable having two ends, one end is mounted securely in the phone slot and the other end is a free end and is mounted to the signal transmitting and receiving contacts of the mobile phone connecting interface.
